(19) United States
(12) Patent Application Publication
(10) Pub. No.: US 2025/0058692 A1
(43) Pub. Date: Feb. 20, 2025

(54) ADJUSTABLE HEIGHT A-FRAME FOR HOOK-LIFTS

(71) Applicant: Bonnell Industries, Inc., Dixon, IL (US)

(72) Inventor: Jacob A. Onley, Rockford, IL (US)

(21) Appl. No.: 18/449,123

(22) Filed: Aug. 14, 2023

(51) Int. Cl. B60P 1/64

(52) U.S. Cl. CPC B60P 1/6409; B60P 1/6418

(57) ABSTRACT

A sub-frame for a hook-lift skid includes a sub-frame body having a top end and a bottom end. The sub-frame includes a coupling at the top end. The coupling has an adjustable portion. The adjustable portion is moveable between a first state at a first distance from the bottom end and a second state at a second distance from the bottom end.

### FIELD OF THE INVENTION

This invention generally relates to hook-lift assemblies for trucks and more specifically to sub-frames for truck hook-lift assemblies.

### BACKGROUND OF THE INVENTION

Hook-lifts also known as hook-lift hoists are installed on truck chassis in order to allow an operator of the truck to load and unload various types of heavy equipment. The heavy equipment can cover a nearly unlimited number of fields and equipment types, for example, storage containers, dumpsters, recycling containers, transport containers, vacuum containers for leaves or sewage, and salt spreaders to name just a few of the nearly infinite numbers of types of equipment that can be lifted by the hook-lifts on trucks.

Many truck owners, either independent owner or businesses or government entities find it useful and very economical to purchase a truck that has a hook-lift installed on the truck that can be used for many different types of equipment. For example, a city might use the truck with the hook-lift in the fall to lift a leaf vacuum collection device onto the truck. Then, in the winter, the hook-lift is used to unload the leaf vacuum device, and a salt spreading device is lifted and secured onto the truck for winter operations. Occasionally, events in the city might require dumpsters to be moved to various locations in the city. Therefore, the hook-lifts can unload the current equipment on the hook-lift, e.g. the leaf-vacuum device, and pick up and move the dumpsters as needed.

Each piece of equipment picked up by the hook-lift typically uses a sub-frame. A sub-frame provides the important connection between the hook-lift and the equipment. Owners may buy one or more sub-frames for each piece of equipment they have. For example, the leaf-vacuum device is fitted to a sub-frame while the salt spreader is attached to yet another sub-frame. The equipment is either sitting on the sub-frame, secured to the sub-frame via weldment or straps for example, or is actually part of the equipment at the manufacture. The sub-frame generally provides the structural support and arrangement to facilitate its movement and lifting onto the truck by the hook-lift.

While one sub-frame can be moved from one piece of equipment to another, typically, each piece of equipment has its own sub-frame. Thus, the operator of a truck having a hook-lift can easily load and unload equipment without losing time and effort installing a sub-frame on each piece of equipment.

Prior Art FIG. 6 illustrates the first figure (annotated) of U.S. Pat. No. 7,341,419, “Mechanism For Securing a Tilt Frame of a Hook Lift Hoist To A Truck Frame,” to Jerome T. Fink et al. A hook-lift 10 having a hook 12 at a height H1 on jib 14 is at the same as the height H2 of the coupling member 16 of a sub-frame 18 attached to the container 20 to be picked up by the hook-lift 10. If the height H1 and H2 were not the same, then the coupling member 16 would not be received by the hook 12 and the container 20 would not seat or be properly secured on the hook-lift 10. A properly received and seated sub-frame 22 on a hook-lift 24 is shown in Prior Art FIG. 7. The height H3 of the hook 24 on the jib 26 of the hook-lift 24 is the same as the height H3 of the coupling 28 on the sub-frame 30.

Unfortunately, on many trucks having a hook-lift, the height of the hook on the jib of the hook-lift, and above the truck bed on the truck, is not always compatible with the height of the coupling member on the sub-frame of the equipment. Where this occurs, the owner may have to either modify the existing hook-lift on the truck, alternatively modify the sub-frame, or purchase a sub-frame that has the needed coupling height. This can be a time-consuming and costly process and may require a third party with enough experience with either the hook-lift or the sub-frame to modify it as necessary so the hook-lift can be used with the sub-frame. Even if the modification is made, the next piece of equipment using or having another sub-frame may require yet another modification of the sub-frame so that the height of the hook is compatible with the height of the coupling member.

### BRIEF SUMMARY OF THE INVENTION

The invention provides a sub-frame with an adjustable coupling height that permits the sub-frame to be useable with hook-lifts having different hook heights on their respective jibs. The sub-frame can be easily adjusted to work with the existing hook-lift of a truck without having to make permanent structural modifications to either the sub-frame or the existing hook-lift. Thus, the sub-frame of the present invention saves time and expense by eliminating the need for purchasing multiple sub-frames having different coupling heights. Moreover, labor cost is saved because users do not have to mechanically alter an existing sub-frame or hook-lift so as to make them fit together and work together. Sale and resale of the sub-frame is more likely because the sub-frame is more likely to fit more vehicles. These and other advantages of the invention, as well as additional inventive features, will be apparent from the description of the invention provided herein.

In one aspect, the invention provides a sub-frame for a hook-lift skid. The sub-frame includes a sub-frame body having a top end and a bottom end. The sub-frame includes a coupling at the top end. The coupling has an adjustable portion. The adjustable portion is moveable between a first state at a first distance from the bottom end and a second state at a second distance from the bottom end.

In another aspect, the invention provides a sub-frame for use with hook-lift skids having hooks at different jib heights. The sub-frame is an A-frame including a coupling at a top end of the A-frame. The coupling has a first state mounted to a first mounting area at a top of the A-frame. The coupling has a second state mounted to a second area at the top of the A-frame.

In an embodiment, the adjustable portion includes a bar extending between a first mounting plate and a second mounting plate.

In an embodiment, the bar extends axially through both the first and the second mounting plates such that axially extending ends of the bar are received into mounting notches defined by an outer peripheral surface of opposite sides of the coupling.

In an embodiment, a first pair of axially aligned mounting notches receive the bar in the first state and a second pair of axially aligned notches, different than the first pair, receive the bar in the second state.

In an embodiment, the mounting notches are defined between adjacent through-holes defined by opposite sides of the coupling.

In an embodiment, fasteners removably fix the first mounting plate and the second mounting plate to the coupling.

In an embodiment, the fasteners are bolts. A first pair of bolts extend through the first mounting plate and a first pair of through holes in a first side of the coupling and a second pair of bolts extend through the second mounting plate and another first pair of through holes in a second side of the coupling to place the adjustable portion in the first state.

In an embodiment, removal of the bolts permits the adjustable portion to be moved such that the first mounting plate and a second pair of though holes in the first side of the coupling and the second mounting plate and another second pair of through holes in the second side of the coupling may receive the bolts to place the adjustable portion in the second state.

In an embodiment, any one or combination of more than one of the first pair of through holes and the another first pair of through holes and the second pair of through holes and the another second pair of through holes have bosses providing structural support.

In an embodiment, wherein the coupling is sized to receive a hook of the hook-lift skid.

In an embodiment, the sub-frame body comprises a first leg spaced apart from a second leg. The coupling joins the first leg and the second leg at the top end.

In an embodiment, the first leg extends from the coupling to contact a first rail at the bottom end and the second leg extends from the coupling to contact a second rail at the bottom end. The first rail and the second rail extending parallel to one another and in a direction extending away from the first leg and the second leg.

In an embodiment, the first leg and the second leg extend away from one another in extension from the top end to the bottom end such that a first width at the top end, measured between the first leg and the second leg, is less than the second width at the second leg measured between the first leg and the second leg.

In an embodiment, opposite sides of the coupling extend parallel to one another such that a constant width is created between the opposite sides.

In an embodiment, a first leg longitudinal axis is defined by the first leg. A second leg longitudinal axis is defined by the second leg. A first side longitudinal axis is defined by the first side. A second side longitudinal axis is defined by second side. The first leg longitudinal axis and the first side longitudinal axis extend transverse one another and the second leg longitudinal axis and the second side longitudinal axis extend transverse to one another.

In an embodiment, the adjustable portion is moveable between the first state and a third state at a third distance from the bottom end, the third distance is different than the first distance and the second distance. The adjustable portion is also moveable between the second state and the third state.

In an embodiment, the first mounting area defines a first distance from the bottom of the A-Frame and the second mounting area defines a second distance from the bottom of the A-frame.

In an embodiment, the coupling includes a bar defining a central longitudinal bar axis. The bar includes a first end of the bar, a first mounting plate at the first end, a second end of the bar, and a second mounting plate at the second end. The bar extends longitudinally between the first mounting plate and the second mounting plate such that the central longitudinal axis projects through the first and second mounting plates.

In an embodiment, the first end is welded to the first mounting plate and the second end is welded to the second mounting plate.

In an embodiment, removable fasteners fasten the coupling to the first mounting area in the first state and the removable fasteners fasten the coupling to the second mounting area in the second state.

Other aspects, objectives, and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 illustrates a sub-frame in a first state according to the teachings of the instant application and as attached to a hook-lift;

FIG. 2 is the sub-frame of FIG. 1 in a second state;

FIG. 3 is an adjustable portion of a coupling of the sub-frame of FIG. 1;

FIG. 4 is the sub-frame of FIG. 2 with the adjustable portion of the coupling removed for the purposes of illustration;

FIG. 5 is another view of the coupling of FIG. 2;

FIG. 6 is a PRIOR ART hook-lift on a truck and a sub-frame with coupling on a container; and

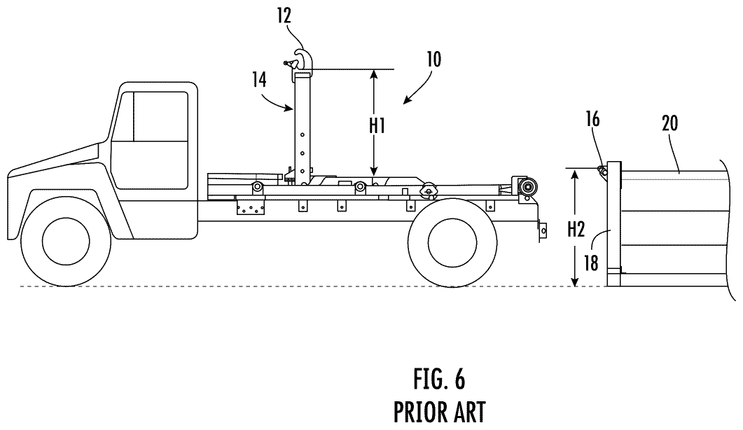

FIG. 7 is another PRIOR ART hook-lift with a mounted sub-frame.

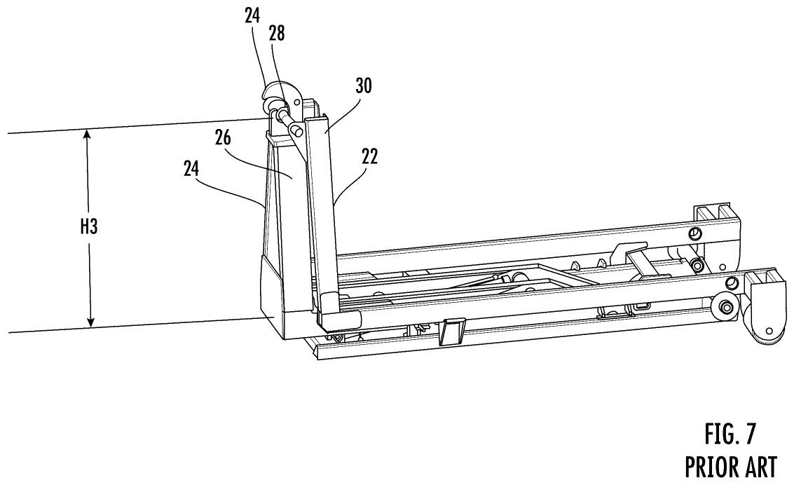

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

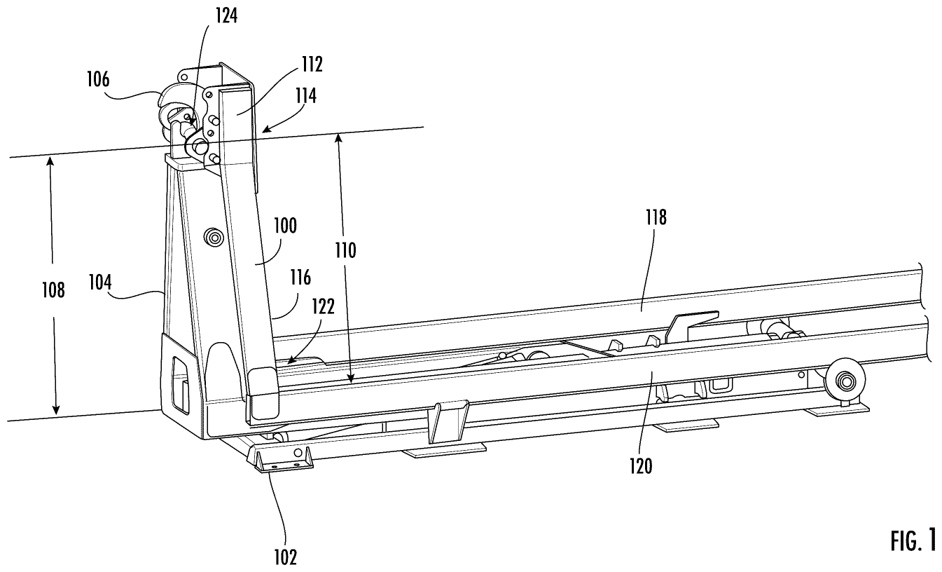

Turning to FIG. 1, a sub-frame 100, according to the teachings of the instant application, is illustrated in a secured position on a hook-lift skid 102 of a truck. The hook-lift skid 102 has a jib 104 and a hook 106 on the jib at a height 108 that is compatible with a height 110 of a coupling 112 at a top end 114 of a sub-frame body 116 of the sub-frame 100. The sub-frame body 116 is an A-frame. It is important that the coupling 112 be both positioned on the top end 114 of the sub-frame body 116 and sized such that it can receive the hook 106 of the hook-lift skid 102. The sub-frame 100 is made of metal to withstand the heavy loads and forces it experiences in use.

A pair of parallel rails 118, 120 are mounted to a bottom end 122 of the sub-frame body 116 and extend away from the sub-frame body 116. The coupling 112 has an adjustable portion 124. The adjustable portion 124 is moveable to change its height 110 above the pair of rails 118, 120 at the bottom end 122 of the sub-frame body 116. FIG. 1 shows the adjustable portion 124 in its first state at a first height 110 above the bottom end 122.

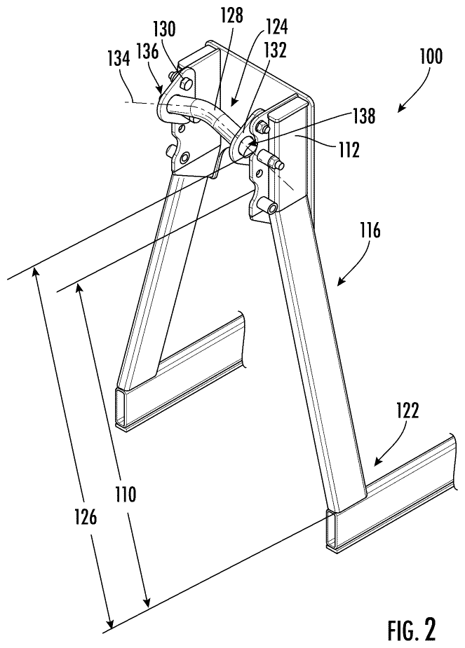

FIG. 2 illustrates the sub-frame 100 without the hook-lift 102 (FIG. 1). FIG. 2 shows the adjustable portion 124 of the coupling 112 in a second state wherein the adjustable portion 124 is at a second height 126 above the bottom end 122 of the sub-frame body 116. The second height 126 is greater than the first height 110. While only an embodiment showing a first and second state and first height 110 and second height 126 are shown, it can be readily appreciated that a third state with the adjustable portion 124 at a third height, different than the first and the second height, can be provided. Moreover, additional states can be provided by the coupling 112 that is constructed to provide for the adjustable portion 124 to be located at different heights above the bottom end 122 of the sub-frame body 116. The heights 110 and 126 may also be referred to as vertical heights.

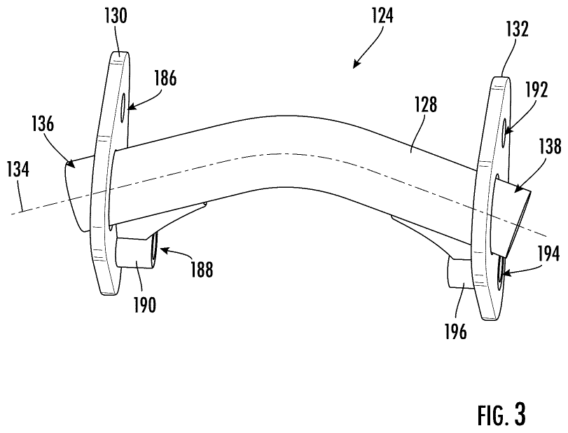

With respect to FIG. 2 and FIG. 3, the adjustable portion 124 comprises a bar 128 extending between a first mounting plate 130 and a second mounting plate 132. First mounting plate 130 includes mounting holes 186, 188. Either mounting hole may include a boss 190 to prevent wear on the holes 186, 188 and/or fasteners extending therethrough when the first mounting plate 130 is mounted to the coupling 112.

Second mounting plate 132 includes holes 192, 194 and may include boss 196 to prevent wear on the holes 192, 194 and/or fasteners extending therethrough when the mounting plate 132 is mounted to the coupling 112. The fasteners may be said to removably fix the adjustable portion 124 to the coupling 112. Thus, by removably fixed, it is meant that a user can simply unbolt the fasteners by removing the nuts thereon, remove the bolts from the through holes through which they extend, adjust the vertical height of the adjustable portion 124 as desired, and reinsert the fasteners at the new mounting site and tightening them with nuts. Thus, no weldments need to be broken, nor any structure members cut, to adjust vertical height of the adjustable portion 124 of the coupling 112.

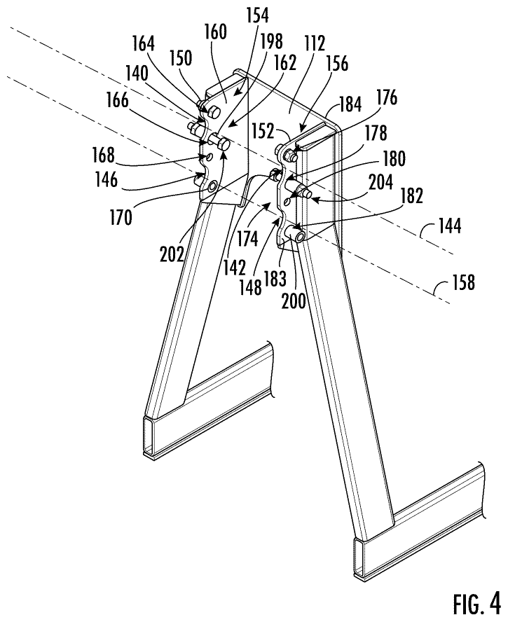

The bar 128 defines a central bar longitudinal axis 134. The bar 128 extends axially beyond the first mounting plate 130 and axially beyond the second mounting plate 132 such that axially extending ends 136, 138 of the bar 128 are received into mounting notches 140, 142 (FIG. 4) also referred to as clearance cut outs. The bar 128 is fixed to the first mounting plate 130 and second mounting plate 132. Fixation may be by weldment, however, as can be readily appreciated, other fixation means are possible, for example, the bar 128 could be integral with the first mounting plate 130 and the second mounting plate 132. The mounting notches 140, 142 (FIG. 4) are aligned along a central axis 144 defined by the mounting notches 140, 142.

In the first state of the adjustable portion 124 (FIG. 1), axial ends 136, 138 (FIG. 3) are received into mounting notches 146, 148 (FIG. 4) defined by outer peripheral surfaces 150, 152 (FIG. 4) of opposite sides 154, 156 (FIG. 4) of the coupling 112 (FIG. 4). Mounting notches 146, 148 (FIG. 4) are aligned along a central axis 158 (FIG. 4) defined by the mounting notches 146, 148 (FIG. 4).

The axially extending end 136, 138 of bar 128 allow for welds on the axial outer faces of the first mounting plate 130 and the second mounting plate 132 to join the axial ends 136, 138 to the first mounting plate 130 and the second mounting plate 132. The axial extending ends 136, 138 eliminate the need for a critically measured angled cut on the bar 128. However, it can also now be readily appreciated that in an embodiment that the axial ends 136, 138 need not extend through the first mounting plate 130 and the second mounting plate 132, but instead may be flush against the axially inner face of the first mount plate 130 and the axial inner face of the second mounting plate 132. In such embodiment without axial extending ends 136, 138 extending through the first mounting plate 130 and the second mounting plate, there is no need for the coupling 112 to include mounting notches 140, 142, 146, 148. Indeed, bar 128 and first mounting plate 130 and second mounting plate 132 may be integral. For example, they may be forged as one piece to provide the adjustable portion 124 of the coupling 112.

As seen in FIG. 4, side 154 can include a bracket 160. The side 154 defines a plurality of through holes 162 including holes 164, 166, 168, 170. Bracket 160 may define the plurality of through holes 162. Mounting notch 140 is defined between holes 164, 166. Mounting notch 140 and holes 164, 166 are a mounting area of the coupling 112 for the adjustable portion 124. Mounting notch 146 is defined between holes 168, 170. Mounting notch 146 and holes 168, 170 are a mounting area of the coupling 112 for the adjustable portion 124.

The side 156 defines a plurality of through holes 174 including holes 176, 178, 180, 182. A bracket 183 may define the plurality of through holes 174. Mounting notch 142 is defined between holes 176, 178. Mounting notch 142 and holes 176, 178 are a mounting area of the coupling 112 for the adjustable portion 124. Mounting notch 148 is defined between holes 180, 182. Mounting notch 148 and holes 180, 182 may define a mounting area for the adjustable portion 124 of the coupling 112. A back plate 184 joins sides 154, 156 of the coupling 112.

Holes 186, 188 (FIG. 3) of the first mounting plate 130 (FIG. 3) axially align with a pair 164, 166 (FIG. 4) of the plurality of through holes 162 (FIG. 4) of the coupling 112 (FIG. 4) while holes 192, 194 (FIG. 3) of the second mounting plate 132 (FIG. 3) axially align with a pair 176, 178 (FIG. 4) of the plurality of through holes 174 (FIG. 4) of the coupling 112 (FIG. 4) to mount the adjustable portion 124 (FIG. 3) in the second state (FIG. 2).

Holes 186, 188 (FIG. 3) of the first mounting plate 130 (FIG. 3) axially align with another pair 168, 170 (FIG. 4) of the plurality of through-holes 162 (FIG. 4) of the coupling 112 (FIG. 4) while holes 192, 194 (FIG. 3) of the second mounting plate 132 (FIG. 3) axially align with another pair 180, 182 (FIG. 4) of the plurality of through holes 174 (FIG. 4) of the coupling 112 (FIG. 4) to mount the adjustable portion 124 (FIG. 3) in the first state (FIG. 1). The plurality of holes 162, 174 may include a boss 198, 200 to prevent wear and fatigue at the plurality of holes 162, 174 or the fasteners that extend therethrough.

As can be readily appreciated at this point in the disclosure, a plurality of fasteners 202, 204 removably fix the adjustable portion 124 to the coupling 112. By removably fixed, it is meant that a user can easily loosen the fasteners 202, 204, remove them from their extension through the mounting plates 130, 132 and coupling 112 to move the adjustable portion to another mounting area of the coupling 112 to move the coupling from its first height 110 in its first state to its second height 126 in its second state and from its second height 126 in its second state to its first height 110 in its first state. The plurality of fasteners 202, 204 may be bolts and nuts, but other fasteners can be used, e.g., pins with detents.

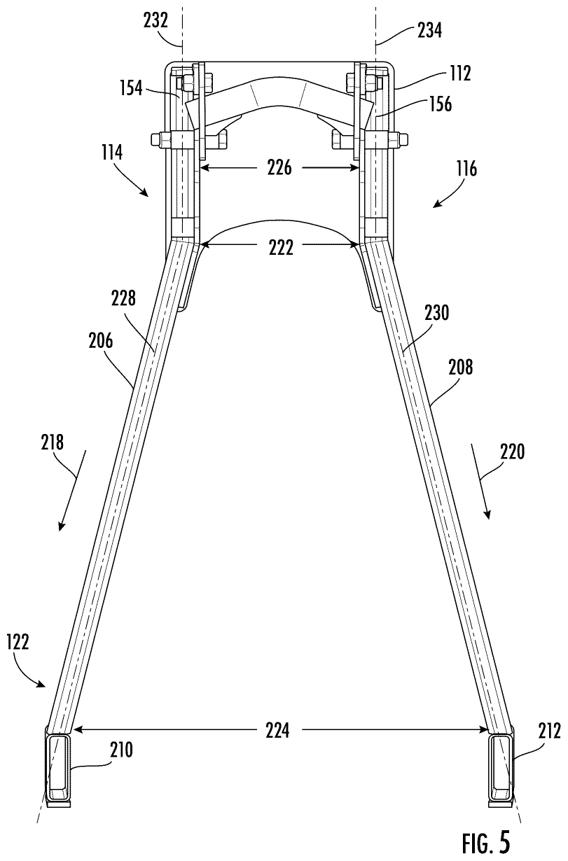

Turning now to FIG. 5, the sub-frame body 116 is an A-frame that includes a first leg 206 spaced apart from a second leg 208. The coupling 112 joins the first leg 206 and the second leg 208 at the top end 114. The first leg 206 extends from the coupling 112 to contact a first rail 210 at the bottom end 122 and the second leg 208 extends from the coupling 112 to contact a second rail 212 at the bottom end 122. The first rail 210 and the second rail 212 extend parallel to one another as they extend away from the first leg 206 and the second leg 208.

The first leg 206 and the second leg 208 extend away from one another in direction 218, 220 that extend from the top end 114 to the bottom end 122 such that a first width 222 at the top end 114 as measured between the first leg 206 and the second leg 208 is less than a second width 224 at the bottom end 122 as measured between the first leg 206 and the second leg 208. The opposite sides 154, 156 of the coupling 112 extend parallel to one another such that a constant width 226 is created between the opposite sides 154, 156.

A first leg longitudinal axis 228 is defined by the first leg 206. A second leg longitudinal axis 230 is defined by the second leg 208. A first side longitudinal axis 232 is defined by the first side 154 of the coupling 112. A second side longitudinal axis 234 is defined by second side 156. The first leg longitudinal axis 228 and the first side longitudinal axis 232 extend transverse one another. The second leg longitudinal axis 230 and the second side longitudinal axis 234 extend transverse to one another.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A sub-frame for a hook-lift skid, the sub-frame comprising:
a sub-frame body having a top end and a bottom end;
a coupling at the top end;
wherein the coupling has an adjustable portion, the adjustable portion moveable between a first state at a first distance from the bottom end and a second state at a second distance from the bottom end.

2. The sub-frame of claim 1, wherein the adjustable portion comprises a bar extending between a first mounting plate and a second mounting plate.

3. The sub-frame of claim 2, wherein the bar extends axially through the first and the second mounting plates such that axially extending ends of the bar are received into mounting notches defined by an outer peripheral surface of opposite sides of the coupling.

4. The sub-frame of claim 3, wherein a first pair of axially aligned mounting notches receive the bar in the first state and a second pair of axially aligned notches different than the first pair receive the bar in the second state.

5. The sub-frame of claim 4, wherein the mounting notches are defined between adjacent through-holes defined by opposite sides of the coupling.

6. The sub-frame of claim 4, wherein fasteners removably fix the first mounting plate and the second mounting plate to the coupling.

7. The sub-frame of claim 6, wherein the fasteners are bolts, a first pair of bolts extend through the first mounting plate and a first pair of through holes in a first side of the coupling and a second pair of bolts extend through the second mounting plate and another first pair of through holes in a second side of the coupling to place the adjustable portion in the first state.

8. The sub-frame of claim 7, wherein removal of the bolts permits the adjustable portion to be moved such that the first mounting plate and a second pair of though-holes in the first side of the coupling and the second mounting plate and another second pair of through holes in the second side of the coupling receive the bolts to place the adjustable portion in the second state.

9. The sub-frame of claim 8, wherein any one or combination of more than one of the first pair of through holes and the another first pair of through holes and the second pair of through holes and the another second pair of through holes have bosses providing structural support.

10. The sub-frame of claim 1, wherein the coupling is sized to receive a hook of the hook-lift skid.

11. The sub-frame of claim 1, wherein the sub-frame body comprises a first leg spaced apart from a second leg, the coupling joins the first leg and the second leg at the top end.

12. The sub-frame of claim 11, wherein the first leg extends from the coupling to contact a first rail at the bottom end and the second leg extends from the coupling to contact a second rail at the bottom end, the first rail and the second rail extending parallel to one another and in a direction extending away from the first leg and the second leg.

13. The sub-frame of claim 12, wherein the first leg and the second leg extend away from one another in extension from the top end to the bottom end such that a first width at the top end measured between the first leg and the second leg is less than the second width at the second leg measured between the first leg and the second leg.

14. The sub-frame of claim 11, wherein opposite sides of the coupling extend parallel to one another such that a constant width is created between the opposite sides.

15. The sub-frame of claim 13, wherein
a first leg longitudinal axis is defined by the first leg;
a second leg longitudinal axis is defined by the second leg;
a first side longitudinal axis is defined by the first side;
a second side longitudinal axis is defined by second side;
wherein the first leg longitudinal axis and the first side longitudinal axis extend transverse one another and the second leg longitudinal axis and the second side longitudinal axis extend transverse to one another.

16. The sub-frame of claim 1, wherein the adjustable portion is moveable between the first state and a third state at a third distance from the bottom end, the third distance is different than the first distance and the second distance, and the adjustable portion is moveable between the second state and the third state.

17. A sub-frame for use with hook-lift skids having hooks at different jib heights, the sub-frame comprising;
an A-frame;
a coupling at a top end of the A-frame;
wherein the coupling has a first state mounted to a first mounting area at a top of the A-frame and a second state mounted to a second area at the top of the A-frame.

18. The sub-frame of claim 17, wherein the first mounting area defines a first distance from the bottom of the A-Frame and the second mounting area defines a second distance from the bottom of the A-frame.

19. The sub-frame of claim 17, wherein the coupling comprises:
a bar defining a central longitudinal bar axis;
a first end of the bar;
a first mounting plate at the first end;
a second end of the bar;
a second mounting plate at the second end;
wherein the bar extends longitudinally between the first mounting plate and the second mounting plate.

20. The sub-frame of claim 17, wherein removable fasteners fasten the coupling to the first mounting area in the first state and the removable fasteners fasten the coupling to the second mounting area in the second state.
